(19) United States
(12) Patent Application Publication
(10) Pub. No.: US 2016/0137499 A1
(43) Pub. Date: May 19, 2016

(54) DEGASSING SYSTEM AND DEVICE FOR DEGASSING LIQUID SULFER

(71) Applicant: CONTROLS SOUTHEAST, INC., Pineville, NC (US)

(72) Inventors: Brian Nathaniel Greenway Groves, Charlotte, NC (US); Brandon W. Forbes, Fort Mill, SC (US); Thomas C. Willingham, Weddington, NC (US)

(21) Appl. No.: 14/940,860

(22) Filed: Nov. 13, 2015

Related U.S. Application Data
(60) Provisional application No. 62/079,816, filed on Nov. 14, 2014.

(51) Int. Cl. C01B 17/02; B01J 19/24

(52) U.S. Cl. CPC C01B 17/0232; B01J 19/24; B01J 2219/00103; B01J 2219/24

(57) ABSTRACT

Embodiments of the invention are directed to a sulfur recovery system that utilizes a degassing system for degassing liquid sulfur. The degassing system includes a degassing device vessel, a pressure equalizer, a motive force device, a sulfur cooler, and/or a process gas cooler. The degassing system may be located within or outside of the sulfur recovery unit and utilizes the process gas from the sulfur recovery unit. The degassing device may receive liquid sulfur and process gas, which are passed through a catalyst, which along with the process gas, degasses the liquid sulfur. As such, the degassing system when used within the sulfur recovery unit degasses the liquid sulfur to reduce off-gassing of dangerous hydrogen sulfide during storage and transportation without the need for additional equipment to degas the liquid sulfur during or after the sulfur storage.

### CROSS-REFERENCE TO PRIORITY APPLICATION

This Non-provisional patent application claims the benefit of U.S. Provisional Patent Application Ser. No. 62/079,816 entitled “Degassing System and Device for Degassing Liquid Sulfur” filed on Nov. 14, 2014, which is hereby incorporated by reference in its entirety.

### FIELD

This application relates generally to the field of sulfur recovery systems and a device within a sulfur recovery system for degassing liquid sulfur, and more particularly to a system for catalytically removing mechanically and chemically bound hydrogen sulfide from the liquid sulfur before storing the liquid sulfur.

### BACKGROUND

Sulfur recovery systems are used in a variety of industrial applications for recovering sulfur. Initially, elemental sulfur is recovered from gaseous compounds that are typically produced as by-products from refining crude oil and other industrial processes. The process of recovering elemental sulfur from gaseous compounds is a multi-step process, wherein the gaseous compounds are processed to progressively convert sulfur typically in the form of hydrogen sulfide to liquid elemental sulfur.

The Claus process is one such gas desulfurizing process for recovering elemental sulfur from gaseous hydrogen sulfide. The Claus process was first developed in the 1880's and has become an industry standard for refineries, chemical plants and natural gas processing plants. Typically, elemental sulfur is produced by a thermal step and several catalytic steps. Elemental sulfur is separated from the Claus plant as a liquid at one or more condensers and is stored for further processing and/or removal.

As petroleum and natural gas contain ever increasing amounts of sulfur compounds, while fuel regulations increasingly tend to mandate lower levels of allowable sulfur in fuel, the Claus process has become increasingly important and prevalent for refineries, chemical plants and natural gas processing plants. Therefore, there is a need for systems, devices and methods for adequately and efficiently degassing liquid sulfur.

### BRIEF SUMMARY

Embodiments of the invention are directed to systems for degassing liquid sulfur. A sulfur degassing vessel (e.g., which can otherwise be described as a degassing apparatus, degassing device, or the like) may be provided to operate in conjunction with a sulfur recovery system in order to degasses the liquid sulfur in the sulfur recovery system within the pressure envelope of the sulfur recovery system without creating a waste stream that must be treated. In some embodiments, in order for the degassing vessel to operate properly, the degassing vessel may be a part of a degassing system within the sulfur recovery system, which may further include one or more pressure equalizers, one or more motive devices, one or more sulfur coolers, and/or one or more process gas coolers as will be described throughout this specification in further detail. The sulfur degassing system of the present invention may provide for proactive removal of H₂S before delivery of the liquid sulfur to sulfur storage. The sulfur storage (otherwise described as sulfur storage container) may comprise sulfur pits, sulfur collection vessels, sulfur collection headers or any other suitable means for collection and/or storage of liquid sulfur.

While sulfur condensers employed in Claus processes have proven satisfactory for condensing sulfur, the quality of the sulfur condensed and the efficiency of the Claus process may be improved by the embodiments of the present invention. Condensed sulfur includes dissolved hydrogen sulfide, present in the liquid sulfur as both mechanically bound H₂S and chemically bound H₂Sₓ, and commonly collectively referred to as H₂S. Over an extended time, the H₂S will eventually disassociate from the liquid sulfur and accumulate as a toxic and flammable gas in vapor spaces at the top of the sulfur storage (e.g., in a sulfur collection vessel, delivery trucks, rail cars, or the like, or other containers). Since an unsafe condition is possible until the sulfur is fully degassed of dissolved H₂S, precautionary steps are required prior to opening a sulfur container and while transferring liquid sulfur from one container to another, which increases costs and results in a dangerous environment for individuals working near the vapor spaces.

The liquid sulfur produced in a sulfur recovery system inherently contains not only dissolved H₂S but also chemically bound H₂Sₓ, (with x>1), often referred to as polysulfides. H₂Sₓ is formed at high temperatures (e.g. 318° Fahrenheit and above) and is also chemically bound to sulfur and cannot be mechanically removed. This is due in part to the fact that its natural breakdown is extremely slow as it has a half-life of approximately 500 minutes. H₂Sₓ will convert back to H₂S and elemental sulfur in time through an equilibrium reaction which may be accelerated with a catalyst in a degassing process.

Thorough degassing of liquid sulfur may be performed before storing the sulfur because capturing and disposing of H₂S emanating from liquid sulfur presents several issues. If the elemental sulfur is not adequately degassed, H₂S will naturally emanate from the sulfur. This H₂S is a toxic and explosive gas that is immediately harmful to life and health. Furthermore, H₂S emanating from liquid sulfur in a closed container can quickly reach the Lower Explosion Limit (“LEL”) in the vapor space above the liquid sulfur within the closed container. When H₂S is in concentrations above the LEL, the container is at risk for explosion. Additionally, solid sulfur products made from undegassed liquid sulfur are more friable, and prone to dust induced explosions.

H₂S emissions from liquid sulfur storage may become a fugitive emission in an area that is closely monitored for environmental compliance. In some instances, up to half of the reported emissions from a Claus sulfur recovery plant can come from H₂S emanating from liquid sulfur in storage. Without degassing operations or adequate capture and disposal technology, these additional emissions may limit the sulfur processing capability of the sulfur recovery unit.

Embodiments of the degassing system are utilized to degas the liquid sulfur to improve the quality of the liquid sulfur produced by the sulfur recovery unit. Embodiments of the invention are directed to a degassing system for a sulfur recovery system. In some embodiments, the degassing system comprises a degassing vessel, wherein the degassing vessel is configured to receive liquid sulfur from one or more condensers and process gas from any location of the sulfur recovery system, wherein the degassing vessel outputs degassed liquid sulfur for storage, and wherein the degassing vessel returns the process gas used to degas the liquid sulfur to the sulfur recovery system at any location; and a downstream pressure equalizer, wherein the downstream pressure equalizer receives the degassed liquid sulfur from the degassing vessel, separates the degassed liquid sulfur from any remaining gas, and delivers the degassed liquid sulfur to sulfur storage without the remaining gas.

In some embodiments, and in combination with the above embodiments, the degassing system further comprises a motive force device configured to supplement pressure of the process gas exiting the degassing vessel and being returned to the sulfur recovery system.

In some embodiments, and in combination with any of the above embodiments, the degassing system further comprises at least one sulfur cooler, configured to receive the liquid sulfur from the one or more condensers, cool the liquid sulfur to lower the solubility of H₂S before delivering the liquid sulfur to the degassing vessel, and deliver the liquid sulfur to the degassing vessel.

In some embodiments, and in combination with any of the above embodiments, the degassing system further comprises at least one gas cooler configured to receive the process gas from the sulfur recovery system, cool the process gas to prevent polymerization of the degassed liquid sulfur or reintroduction of H₂S in the degassed liquid sulfur, and provide the process gas to the degassing vessel.

In some embodiments, and in combination with any of the above embodiments, the liquid sulfur is received from one or more upstream pressure equalizers located downstream of the one or more condensers and upstream of the degassing vessel, and wherein the one or more upstream pressure equalizers are configured to receive the liquid sulfur from the one or more condensers, separate the process gas from the liquid sulfur, and deliver the liquid sulfur to the degassing vessel.

Some embodiments of the invention are directed to a degassing system for a sulfur recovery system, comprising: a degassing vessel, wherein the degassing vessel is configured to receive liquid sulfur from one or more condensers and process gas from any location of the sulfur recovery system, wherein the degassing vessel outputs degassed liquid sulfur for storage, and wherein the degassing vessel returns the process gas used to degas the liquid sulfur to the sulfur recovery system at any location; and a motive force device configured to supplement pressure of the process gas exiting the degassing vessel and being returned to the sulfur recovery system.

In some embodiments, and in combination with any of the above embodiments, the degassing system further comprises a downstream pressure equalizer, wherein the downstream pressure equalizer receives the degassed liquid sulfur from the degassing vessel, separates the degassed liquid sulfur from any remaining gas, and delivers the degassed liquid sulfur to sulfur storage without the remaining gas.

In some embodiments, and in combination with any of the above embodiments, the degassing system further comprises at least one sulfur cooler configured to receive the liquid sulfur from the one or more condensers, cool the liquid sulfur to lower the solubility of H₂S before delivering the liquid sulfur to the degassing vessel, and deliver the liquid sulfur to the degassing vessel.

In some embodiments, and in combination with any of the above embodiments, the degassing system further comprise at least one gas cooler configured to receive the process gas from the sulfur recovery system, cool the process gas to prevent polymerization of the degassed liquid sulfur or reintroduction of H₂S in the degassed liquid sulfur, and provide the process gas to the degassing vessel.

In some embodiments, and in combination with any of the above embodiments, the liquid sulfur is received from one or more upstream pressure equalizers located downstream of the one or more condensers and upstream of the degassing vessel, and wherein the one or more upstream pressure equalizers are configured to receive the liquid sulfur from the one or more condensers, separate the process gas from the liquid sulfur, and deliver the liquid sulfur to the degassing vessel.

Some embodiments of the invention are directed to a degassing system for a sulfur recovery system, comprising: a degassing vessel, wherein the degassing vessel is configured to receive liquid sulfur from one or more condensers and process gas from any location of the sulfur recovery system, wherein the degassing vessel outputs degassed liquid sulfur for storage, and wherein the degassing vessel returns the process gas used to degas the liquid sulfur to the sulfur recovery system at any location; and at least one sulfur cooler configured to receive the liquid sulfur from the one or more condensers, cool the liquid sulfur to lower the solubility of H₂S before delivering the liquid sulfur to the degassing vessel, and deliver the liquid sulfur to the degassing vessel.

In some embodiments, and in combination with any of the above embodiments, the degassing system further comprises a downstream pressure equalizer, wherein the downstream pressure equalizer receives the degassed liquid sulfur from the degassing vessel, separates the degassed liquid sulfur from any remaining gas, and delivers the degassed liquid sulfur to sulfur storage without the remaining gas.

In some embodiments, and in combination with any of the above embodiments, the degassing system further comprises a motive force device configured to supplement pressure of the process gas exiting the degassing vessel and being returned to the sulfur recovery system.

In some embodiments, and in combination with any of the above embodiments, the degassing system further comprises at least one gas cooler configured to receive the process gas from the sulfur recovery system, cool the process gas to prevent polymerization of the degassed liquid sulfur or reintroduction of H₂S in the degassed liquid sulfur, and provide the process gas to the degassing vessel.

In some embodiments, and in combination with any of the above embodiments, the liquid sulfur is received from one or more upstream pressure equalizers located downstream of the one or more condensers and upstream of the degassing vessel, and wherein the one or more upstream pressure equalizers are configured to receive the liquid sulfur from the one or more condensers, separate the process gas from the liquid sulfur, and deliver the liquid sulfur to the degassing vessel.

Some embodiments of the invention are directed to a degassing system for a sulfur recovery system, comprising: a degassing vessel, wherein the degassing vessel is configured to receive liquid sulfur from one or more condensers and process gas from any location of the sulfur recovery system, wherein the degassing vessel outputs degassed liquid sulfur for storage, and wherein the degassing vessel returns the process gas used to degas the liquid sulfur to the sulfur recovery system at any location; and at least one gas cooler configured to receive the process gas from the sulfur recovery system, cool the process gas to prevent polymerization of the degassed liquid sulfur or reintroduction of H₂S in the degassed liquid sulfur, and provide the process gas to the degassing vessel.

In some embodiments, and in combination with any of the above embodiments, the degassing system further comprises a downstream pressure equalizer, wherein the downstream pressure equalizer receives the degassed liquid sulfur from the degassing vessel, separates the degassed liquid sulfur from any remaining gas, and delivers the degassed liquid sulfur to sulfur storage without the remaining gas.

In some embodiments, and in combination with any of the above embodiments, the degassing system further comprises a motive force device configured to supplement pressure of the process gas exiting the degassing vessel and being returned to the sulfur recovery system.

In some embodiments, and in combination with any of the above embodiments, the degassing system further comprises at least one sulfur cooler configured to receive the liquid sulfur from the one or more condensers, cool the liquid sulfur to lower the solubility of H₂S before delivering the liquid sulfur to the degassing vessel, and deliver the liquid sulfur to the degassing vessel.

In some embodiments, and in combination with any of the above embodiments, the liquid sulfur is received from one or more upstream pressure equalizers located downstream of the one or more condensers and upstream of the degassing vessel, and wherein the one or more upstream pressure equalizers are configured to receive the liquid sulfur from the one or more condensers, separate the process gas from the liquid sulfur, and deliver the liquid sulfur to the degassing vessel.

Some embodiments of the invention are directed to a degassing system for a sulfur recovery system, comprising: a degassing vessel, wherein the degassing vessel is configured to receive liquid sulfur from one or more upstream pressure equalizers located downstream of one or more condensers and upstream of the degassing vessel and process gas from any location of the sulfur recovery system, and wherein the one or more upstream pressure equalizers are configured to receive the liquid sulfur from the one or more condensers, separate the process gas from the liquid sulfur, and deliver the liquid sulfur to the degassing vessel, wherein the degassing vessel outputs degassed liquid sulfur for storage, and wherein the degassing vessel returns the process gas used to degas the liquid sulfur to the sulfur recovery system at any location; a downstream pressure equalizer, wherein the downstream pressure equalizer receives the degassed liquid sulfur from the degassing vessel, separates the degassed liquid sulfur from any remaining gas, and delivers the degassed liquid sulfur to sulfur storage without the remaining gas; a motive force device configured to supplement pressure of the process gas exiting the degassing vessel and being returned to the sulfur recovery system; at least one sulfur cooler configured to receive the liquid sulfur from the one or more condensers, cool the liquid sulfur to lower the solubility of H₂S before delivering the liquid sulfur to the degassing vessel, and deliver the liquid sulfur to the degassing vessel; and at least one gas cooler configured to receive the process gas from the sulfur recovery system, cool the process gas to prevent polymerization of the degassed liquid sulfur or reintroduction of H₂S in the degassed liquid sulfur, and provide the process gas to the degassing vessel.

To the accomplishment of the foregoing and the related ends, the one or more embodiments comprise the features hereinafter described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, where:

FIG. 1 illustrates a system flow diagram of a Claus sulfur recovery system, in accordance with embodiments of the invention.

FIG. 2 illustrates a system flow diagram of a Claus sulfur recovery system including a degassing system, in accordance with embodiments of the invention.

FIG. 3 illustrates a system flow diagram of a Claus sulfur recovery system including a degassing vessel operating external to the Claus recovery system, in accordance with embodiments of the invention.

FIG. 4 illustrates a degassing vessel for degassing liquid sulfur, in accordance with embodiments of the invention.

FIG. 5 illustrates a degassing vessel for degassing liquid sulfur, in accordance with embodiments of the invention.

FIG. 6 illustrates a degassing vessel for degassing liquid sulfur, in accordance with embodiments of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

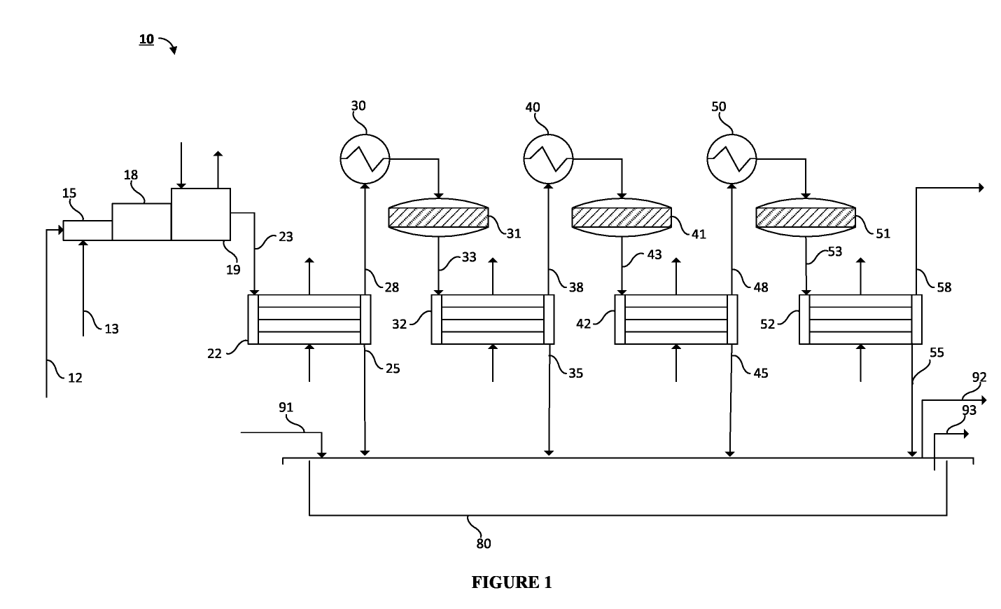

Referring now to FIG. 1, a system diagram for a Claus Sulfur Recovery Plant is generally indicated by the reference number 10 (e.g., also described herein as a “sulfur recovery system 10” or a “sulfur recovery unit 10” (SRU)). Claus Plants have been in use for more than a century at petroleum refineries to produce liquid sulfur from gases containing hydrogen sulfide (“H₂S”). The following is a brief explanation of a Claus sulfur recovery system 10. Although multiple gas desulfurization and sulfur recovery systems may exist, the degassing system of the present invention is described with respect to the Claus process. It should be understood that the degassing system of the present invention may find applications in any gas desulfurization systems, in general, and various sulfur recovery systems in particular, including the Claus sulfur recovery system 10 specifically discussed herein.

Gas having sulfur, typically in the form of H₂S, enters the sulfur recovery system 10 via conduit 12. Oxygen, typically as an unenriched constituent of air, but sometimes enriched with pure oxygen, enters via conduit 13. A burner 15 along with reaction furnace 18 are provided to burn and oxidize at least part of the H₂S to elemental sulfur, SO₂ and water, wherein the overall reaction is:

10H₂S+5O₂→2H₂S+SO₂+7/2S₂+8H₂O

This exothermic reaction produces very hot gases which are cooled down in a waste heat boiler 19 and travel to the first condenser 22 via conduit 23 where the elemental sulfur is condensed and removed at liquid discharge conduit 25. Cooling water is provided to both the waste heat boiler 19 and to the condensers 22, 32, 42, 52 to make steam for use in making electricity or heating elsewhere in the in the Claus Sulfur Recovery Plant 10 or in the larger industrial plant that is not shown. The remaining gases from the first condenser 22 are directed through the gas conduit 28 to reheater 30 where the gases are reheated and then delivered to a catalytic converter bed 31 for conversion of remaining H₂S and SO₂ to elemental sulfur. The reheater 30 reheats the process gas to prevent the sulfur from condensing in the catalytic converter bed 31. The chemical process is generally described as follows:

2H₂S+SO₂→3S+2H₂O

Again, the process gases are cooled in the second sulfur condenser 32 so that elemental sulfur may be condensed to a liquid and removed at the second liquid discharge conduit 35. In this regard, in some embodiments, the process gas may comprise elemental sulfur in vapor form that may be condensed to a liquid after cooling. The gases are directed by a conduit 38 to further sulfur recovery steps including a reheater 40, catalytic reactor 41, and condenser 42 (e.g., the third condenser), and subsequently to another reheater 50, catalytic reactors 41, and condenser 52 (e.g., the fourth condenser) to recover liquid sulfur at discharge conduits 45 and 55.

All of the liquid sulfur produced in condensers 22, 32, 42, 52 contains residual hydrogen sulfide at different concentrations and is produced at different temperatures. The liquid sulfur produced in the first condenser 22 has the highest concentrations of H₂S, often in in the range of about 600 ppmw (e.g., 400 to 800 ppmw, or within, outside or overlapping this range), and the highest temperatures often in the range of about 350° F. (e.g., 320 to 380° F., 340 to 360° F., or within, outside or overlapping these ranges). The liquid sulfur produced in the second condenser 32 has H₂S concentrations often in the range of about 150 ppmw (e.g., 100 to 350 ppmw, or within, outside or overlapping this range) and temperatures often the range of about 330° F. (e.g., 310 to 360° F., 320 to 340° F., or within, outside or overlapping these ranges). The liquid sulfur produced in the third condenser 42 has H₂S concentrations often in the range of about 50 ppmw (e.g., 25 to 100 ppmw, or within, outside or overlapping this range) and temperatures in the range of about 315° F. (e.g., 300 to 350° F., 305 to 325° F., or within, outside or overlapping these ranges). The liquid sulfur produced in the fourth condenser 52 has H₂S concentrations often in the range of about 25 ppmw (e.g., 10 to 35 ppmw, or within, outside or overlapping this range) and temperatures in the range of about 300° F. (e.g., 280 to 340° F., 290 to 310° F., or within, outside or overlapping these ranges). These variations in H₂S concentrations are due in part to the temperature dependent solubility of H₂S in liquid sulfur, and the operating temperature of the condensers. It should be noted that the numbers presented are representative, and actual sulfur temperatures and H₂S concentrations will vary with each sulfur recovery system 10.

The sulfur produced in condensers 22, 32, 42, 52 is traditionally collected in sulfur storage 80 (e.g., sulfur storage pit, or the like) to provide temporary storage of liquid sulfur prior to being sent to long term storage or forming operations. The sulfur storage 80 commonly takes the form of an in-ground concrete container, but can also be constructed in the form of an above-ground collection container. The sulfur storage 80 usually operates at atmospheric pressure, and requires continual exchange of the vapor space to prevent buildup of H₂S that naturally emanates from the liquid sulfur. This exchange of vapor space occurs by “sweeping” air from pit sweep inlet 91 and discharging via conduit 92 to disposal. This sweep air has H₂S concentrations, and therefore is a waste stream that is often sent to the incinerator for conversion to SO₂. If the vapor space of the sulfur storage 80 is not “swept,” the H₂S concentration in the vapor space will eventually reach the Lower Explosion Limit and be at risk for explosion.

Liquid sulfur is pumped from the sulfur storage 80 to long term storage, transportation and/or forming operations via conduit 93. Although not currently required worldwide, many countries require that H₂S be sufficiently removed from the liquid sulfur prior to long term storage, transportation and forming operations (e.g. 10 ppmw in Europe, 30 ppmw in Canada). The process of removing H₂S from liquid sulfur is referred to as “sulfur degassing”, and some technologies exist to “degas” (i.e. remove H₂S from liquid sulfur) the sulfur to below required levels, although, the technologies have limited applications. For instance, existing sulfur degassing technologies operate downstream of the sulfur recovery unit 10, and outside of its respective pressure envelope.

Embodiments of the present invention include degassing liquid sulfur within the sulfur recovery system 10, prior to collection with the sulfur storage 80, and/or utilizing the process gas of sulfur recovery system 10 within the pressure envelope of the sulfur recovery system 10. However, embodiments of the present invention may also be configured to function outside the sulfur recovery system 10.

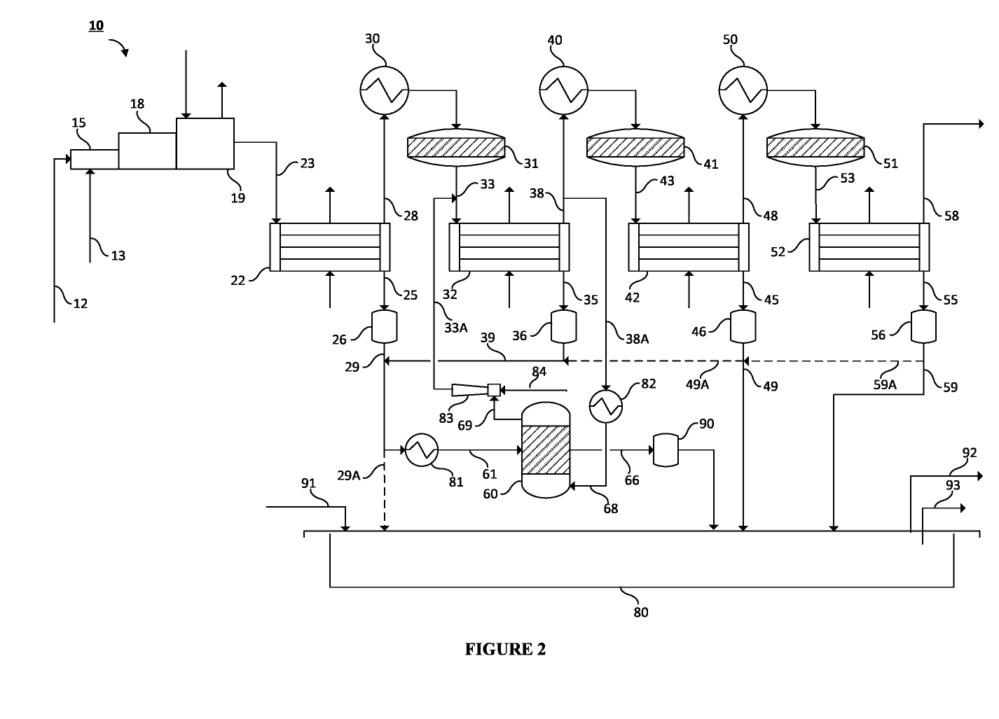

Referring now to FIG. 2, the degassing apparatus of the invention comprises a degassing vessel 60 to degas the liquid sulfur downstream of one or more condensers 22, 32, 42, 52. In some embodiments the degassing vessel may be configured to receive liquid sulfur from the one or more condensers via one or more pressure equalizers 26, 36, 46, 56. The sulfur recovery system 10 operates at elevated pressures, nominally less than 15 psig at the burner and steadily drops as the process gas passes through each component in the system. The pressure equalizers 26, 36, 46, 56 may be utilized between the condensers 22, 32, 42, 52 and the sulfur storage 80 to provide a variety of functions. For example, in some embodiments, the pressure equalizers may act as a liquid seal, allowing liquid sulfur exiting in conduit 25, 35, 45, 55 to travel to the sulfur storage 80, while preventing process gas from traveling along the same path. This maintains the positive pressure in the sulfur recovery system 10 while the sulfur storage 80 continues to operate at or near atmospheric pressure. Additionally, in some embodiments, the pressure equalizers 26, 36, 46, 56 may function to constrain flow along one or more streams and/or act as pressure equalizers to equilibrate the pressure of the liquid sulfur being delivered to vessel 60 from two or more streams, as described in detail elsewhere in the disclosure. In some embodiments, the pressure equalizers 26, 36, 46, 56 may prevent process gas vapor from escaping the condensers 22, 32, 42, 52 and further help in maintaining the pressure within said the condensers 22, 32, 42, 52. It is understood that the pressure equalizers 26, 36, 46, 56 may perform some or all of the above listed functions, in any suitable combination. In some embodiments, the pressure equalizers 26, 36, 46, 56 may be in-ground or above-ground devices, such as sulfur sealing devices, seal legs, sulfur traps, elevation change configurations based on the design of the plant, or the like.

In some embodiments, the degassing vessel 60 is used in conjunction with a downstream pressure equalizer 90, such as a sulfur sealing device, which is located downstream of the degassing vessel 60 and before (e.g., upstream of) the sulfur storage 80 for preventing process gas from reaching the sulfur storage 80 and/or for allowing the degasser vessel 60 and the sulfur storage 80 to operate at different pressures. In this regard, in some embodiments, the downstream pressure equalizer 90 may help maintain the pressure within the degassing vessel 60. In some embodiments, the downstream pressure equalizer may be substantially similar to the upstream pressure equalizers 26, 36, 46, 56, in structure and/or function.

Additionally, in some embodiments, the degassing vessel 60 is configured to receive one or more streams of process gas diverted from the sulfur recovery system 10. For instance, in some embodiments, the degassing system utilizes a degassing vessel 60 in conjunction with upstream pressure equalizers 26, 36, 46, 56 and a downstream pressure equalizer 90, as illustrated in FIG. 2, to degas the liquid sulfur downstream of the pressure equalizers 26, 36 using a process gas slipstream 38A from within the sulfur recovery system 10. The process gas slipstream 38A both assists in catalytic degassing and in carrying away emancipated H₂S gas back to the sulfur recovery system 10, prior to immediate storage of the liquid sulfur in the sulfur storage 80. In other instances, the degassing vessel 60 may receive liquid sulfur from only one of the condensers 22, 32, 42, 52, without a pressure equalizing device, and transmit degassed liquid sulfur to the sulfur storage 80, via the downstream pressure equalizer 90. In this regard, the downstream pressure equalizer may help prevent any process gas that escaped the condenser along with the sulfur stream 25 from reaching the sulfur storage 80. Embodiments of the invention are discussed in further detail as follows.

In some embodiments, the sulfur produced in the first condenser 22 passes through the first pressure equalizer 26 via conduit 25 and travels through conduit 29 towards the sulfur cooler 81 and degassing vessel 60. The pressure equalizer 26 is configured to prevent the process gas in condenser 22 from escaping downstream with the liquid sulfur in conduit 29 while allowing liquid sulfur to pass through, and further prevents backflow of liquid sulfur and/or process gas from the degassing vessel 60 towards the condensers. Additionally, the pressure equalizer 26 may be configured to equilibrate the degassing vessel 60 pressure. As such, in some embodiments, the pressure equalizer 26 may be configured to not only separate the process gas from the liquid sulfur after exiting the condenser 22, but also to control the pressure drops before the degassing vessel 60. It should be understood that the “pressure equalizing” function of the pressure equalizers 26, 36, 43, 56, 90 can occur within a discrete device, or can be integrated to another device or piping arrangement.

In additional embodiments of the invention, the sulfur produced in the second condenser 32 passes through pressure equalizer 36 and travels to conduit 29 via conduit 39. This combines the liquid sulfur streams from condensers 22, 32 that are provided to the degassing vessel 60, and allows for simultaneous processing in sulfur cooler 81. In this regard, it may be noted that the sulfur streams from the condensers may be processed individually or the sulfur streams of any suitable combination of condensers may be directed to the degassing vessel 60, based on the application. For example, the degassing vessel 60 may be optionally arranged to receive liquid sulfur discharged from any combination of condensers 22, 32, 42 and/or 52 for degassing. However, it should be understood that the benefits of degassing the liquid sulfur may be reduced with each successive condenser. Furthermore, although the FIG. 2 illustrates directing the liquid sulfur streams from various condensers, and combining the liquid sulfur streams prior to insertion into the degassing vessel 60, in other embodiments, two or more sulfur streams may enter the degassing vessel separately and at the same or different locations on the degassing vessel 60.

To aid in degassing the sulfur stream sent to the degassing vessel 60, in some embodiments, the liquid sulfur may be routed through a sulfur cooler 81. As detailed previously, the temperatures, flowrates and H₂S concentrations of the sulfur streams 25, 35, 45, 55 differ, with the highest temperatures, flowrates and H₂S concentrations being in streams 25 and 35. Sulfur degassing occurs most readily when the solubility of H₂S in liquid sulfur is lowest, which is typically at about 275° F. In this regard, the liquid sulfur at the inlet of the sulfur cooler 81, may comprise temperatures in the range of 300-380° F. (e.g., 320 to 380° F., 310 to 360° F., 300-350° F., 280-340° F. or within, outside or overlapping these ranges) The sulfur cooler 81 may then cool the liquid sulfur to temperatures of about 260-315° F. (e.g., 255 to 280° F., 270 to 290° F., 265-310° F., or within, outside or overlapping these ranges) before transmitting the liquid sulfur to the degassing vessel 60. As such, in some embodiments the sulfur degassing system may utilize the sulfur cooler 81 to aid in degassing. Although in other embodiments, a sufficiently large degassing vessel 60, with its size increased to 2, 3 or 4 times its volume, might not require a sulfur cooler 81 to compensate for the increase in H₂S solubility at higher sulfur temperatures. In some embodiments, the large degassing vessel 60 may be used in conjunction with a smaller sulfur cooler 81 that delivers liquid sulfur at comparatively higher temperature ranges (e.g., 280-315° F., 290-310° F., 275-315° F., or within, outside or overlapping these ranges), since the large degassing vessel 60 may further lower the temperature of the liquid sulfur to a suitable range.

The sulfur in conduit 29 can alternately be routed via conduit 29A in order to bypass the sulfur cooler 81, degassing vessel 60 and downstream pressure equalizer 90. This bypass operation could be utilized, for instance, during maintenance operations on the sulfur cooler 81, degassing vessel 60, motive force device 83, downstream pressure equalizer 90, and/or other devices.

The sulfur stream to be degassed 29 passes through the sulfur cooler 81 and into the degassing vessel 60. The specific mechanisms internal to the degassing vessel 60 are explained in further detail below. Typically, the degassing vessel 60 is configured to cause the interaction of the liquid sulfur with the process gas slipstream 38A in the presence of a catalyst to degas the liquid sulfur.

After processing the liquid sulfur stream 61 through the degassing vessel 60, the outlet sulfur stream in conduit 66 travels to a downstream pressure equalizer 90. The downstream pressure equalizer 90 may be an above-ground or a below ground device, such as a sulfur sealing device that maintains the gas pressure in the degassing vessel 60, and prevents process gas from traveling to the sulfur storage 80.

In some embodiments the degassing device vessel 60 may receive the liquid sulfur from only the first condenser 22, but this may not be as effective because the liquid sulfur from the second condenser 32 would not be degassed before entering the sulfur storage 80. As such, the degassing device vessel 60 may receive the liquid sulfur from the first condenser 22 and the second condenser 32. In other embodiments the degassing device vessel 60 may be located to also receive liquid sulfur from the third condenser 42 and/or the fourth condenser 52 (along with the first condenser 22 and the second condenser 32); however, the benefit of further degassing the liquid sulfur from the third condenser 42 and/or the fourth condenser 52 may not remove enough H₂S gas from the liquid sulfur (e.g., because the flowrates and amount of H₂S in the liquid sulfur exiting the third and/or fourth condensers 42, 52 may already be low) to outweigh the loss of the pressure drop in the liquid sulfur. The pressure of the liquid sulfur from the first condenser 22 to the last condenser 52 steadily drops, and as such, the lower the pressure of the liquid sulfur entering the degasser vessel 60, the harder it will be to push the liquid sulfur through the catalyst (e.g., in degassers with upward, sideways, or the like liquid sulfur flow). As such, depending on the size of the degassing vessel 60, the amount of catalyst, the height the liquid sulfur has to travel within the degassing vessel, etc., in some embodiments, it may only be practical to utilize the liquid sulfur exiting the first condenser 22 and the second condenser 32 (and in some embodiments the third condenser 42). However, it should be understood that the liquid sulfur from any combination of condensers may be directed to the degassing vessel 60. Moreover, it should be understood that a single degassing device vessel 60 or multiple degassing device vessels 60 may be utilized upstream of the sulfur storage 80 to degas the liquid sulfur 80 before it is sent to the sulfur storage container 80. As such, in some embodiments, the liquid sulfur from the condensers 22, 32, 42 and 52 may exit the condensers and/or may be delivered to the pressure equalizers 26, 36, 46, 56 with pressures in the range of 1 to 13 psig, or within, outside or overlapping this range. For example, the first condenser 22, may comprise vapor pressures in the range of 2 to 13 psig acting on the liquid sulfur. Similarly, the second condenser 32, the third condenser 42 and the fourth condenser 52 may have vapor pressures in the range of 2 to 10 psig, 1 to 9 psig and 1 to 8 psig respectively. However, in other embodiments of the invention the pressures may be within, outside, or overlapping any of these ranges.

In the present invention, the gas used to aid in degassing (e.g., stirring the liquid) in the catalyst zone is H₂S-containing process gas from the sulfur recovery system 10. Process gases received from line 28 may contain about 4% to about 9% by volume H₂S, and typically about 8% by volume H₂S. Process gases in line 38 typically comprise less H₂S, but may have sufficient pressure to agitate the catalyst 62 and still return to the sulfur recovery unit 10. Process gases in line 38 may have between 2% to 5% H₂S by volume and typically about 4% by volume H₂S. Process gases in line 48 may still retain sufficient pressure to be used to agitate the catalyst 62 and may also have a lower H₂S content being about 0.5% H₂S to about 3% H₂S by volume and typically about 1% H₂S to about 2% H₂S by volume.

It should be understood that the Claus catalytic process occurring in degassers is an equilibrium reaction and therefore, gases that have been used for agitating the catalyst always exclude H₂S. Utilizing external gases for agitating a catalyst results in increased expenses due to the additional components needed to store and supply the gases, and the additional costs of procuring the gases (e.g., purchasing the external gas source). Alternatively, using a slipstream of process gas reduces expenses, as the process gas from the sulfur recovery unit is readily available, and the process gas exiting the degassing apparatus has enough H₂S to warrant further sulfur recovery steps or treatment via thermal oxidation in an incinerator. Embodiments of the present invention handle the waste stream from the degassing vessel 60 within the pressure boundary of the sulfur recovery system 10, eliminating a waste stream that must be handled outside of the unit. That said, alternate embodiments of the invention may be devised with the degassing vessel 60 arranged to accommodate other gas sources for use when the process gas slipstream is unavailable, undesirable, or requires additional pressure. This alternate source could be, but is not limited to, a slipstream from the Tail Gas Treatment Unit, air from the sulfur recovery system/blowers, Nitrogen, steam, or other source.

As illustrated in FIG. 2, in one embodiment a slipstream of process gas is taken from conduit 38 via conduit 38A, and routed to the degassing vessel 60. The use of slipstream of the process gas means that the degassing apparatus operates within the pressure envelope of the sulfur recovery system 10. This allows for degassing of liquid sulfur within the sulfur recovery system 10, not external to it. In some embodiments, utilizing the process gas from line 38 (e.g., process gas exiting the second condenser) to degas the liquid sulfur, via line 38A as illustrated in FIG. 2, results in improved degassing performance, in comparison with line 28 for example. However, it should be understood that slipstreams of process gas may be utilized from any one, or combinations thereof, of the one or more of lines 28, 38, 48, 58 and delivered to the degassing vessel 60 to aid in degassing the liquid sulfur.

In some embodiments of the invention, before the process gas is delivered to the degassing device vessel 60 the process gas may be sent through a gas cooler 82. Process gas that is heated above 318° F. has the potential to cause degassed sulfur to combine to form a polymer and/or reintroduce H₂S in the liquid sulfur, thus the gas cooler 82 reduces the temperature of the process gas before it is delivered to the degassing device vessel 60 in order to avoid the polymerization of degassed sulfur and/or the reintroduction of H₂S into the liquid sulfur. In some embodiments of the invention, the process gas is cooled to about 275° F. (e.g., to between 260 to 315° F., 270 to 280° F., 260 to 285° F. or within outside or overlapping these ranges). Although in other embodiments, due to the small size of the process vapor slipstream 38A, in comparison with the sulfur inlet 61, the degasser 60 may be operated with a smaller gas cooler 82, or with no gas cooler 82 at all.

Once the gas has passed through the vessel 60, it exits at exit conduit 69 and rejoins the Claus process. In the illustrated arrangement in FIG. 2, the process gas rejoins the Claus process at conduit 33 via conduit 33A. In some embodiments, the process gas may have sufficient pressure to rejoin the sulfur recovery system 10. In other embodiments of the invention, in order for the gas to have sufficient pressure to rejoin the sulfur recovery system 10 via conduit 33A, a motive force device 83 may be utilized. The motive force device 83 may be an ejector, blower, or other like motive force that increases pressure of the process gas exiting the degassing vessel 10. In some embodiment the ejector may be a steam ejector, a thermo-compressor, or the like. The motive force device 83 may utilize a motive stream 84 to increase the pressure of the slipstream process gas in conduit 69. The motive stream 84 could be, but is not limited to, steam, a slipstream from the Tail Gas Treatment Unit, air, Nitrogen, steam, or other gases/fluids from within or outside the sulfur recovery system, at a suitable pressure. This arrangement of process gas slipstream tie in points allows for no process gas slipstream to bypass a portion of the sulfur recovery system 10. This results in no decrease in overall sulfur recovery from the sulfur recovery system 10 (e.g., the process gas exiting the degassing vessel 10 is not incinerated, or otherwise processed outside of the sulfur recovery system 10). Due to the pressure profile of the sulfur recovery system 10, the process gas slipstream, in some embodiments, may require additional motive force to flow in the desired flow path. For example, when the sulfur recovery system 10 is not operating at full capacity the process gas may be operating a lower pressures, and as such, depending on where the process gas slipstream is coming from (e.g., lines 28, 38, 48, or the like) the process gas may not have enough pressure to move the catalysis and/or be returned back into the sulfur recovery system 10. As such, in some embodiments a motive device 83 may be utilized downstream and/or upstream of the degassing vessel 60.

It should be noted that the process gas may optionally be arranged to be taken from, and rejoined to, any other point in the sulfur recovery system 10. For example, the process gas may be extracted from locations 28, 38, 48, and/or 58 and may be reinserted, after exiting the degassing vessel 60, at one or more suitable locations either upstream or downstream of the original one or more origin points (e.g., 28, 38, 48, and/or 58). For example, with respect to process gas extracted from slipstream 38A, the gas exiting the degassing vessel 60 may be reinserted upstream of 38A at conduit 12, 23, 28, or 33, or downstream of 38A at conduit 43, 48 or 53). In some embodiments, returning the process gas to a location that is upstream of its point of origin may be beneficial since there is no loss of sulfur recovery.

In some embodiments of the invention, degassing of the liquid sulfur within the degassing vessel 60 occurs using only the inherent pressure of the process gas within the sulfur recovery system, and as such no additional force motive force devices 83 (e.g., ejectors, blowers, or the like) are needed to force the process gas and/or other gases through the liquid sulfur recovery system 10. However, alternate embodiments of the invention could be designed to utilize additional motive forces to facilitate the delivery of process gas and/or other gases to, within and away from the apparatus.

Moreover, in some embodiments, degassing of the liquid sulfur within the degassing vessel 60 occurs using only the inherent pressure of the liquid sulfur within the sulfur recovery system 10, and as such no additional motive forces from other liquid sulfur devices (e.g., pumps, or the like) are needed to force the liquid sulfur through the degassing vessel 60. However, alternate embodiments of the invention could be designed to utilize additional forces to facilitate the delivery of sulfur to, within and away from the apparatus.

Embodiments of the invention may be utilized to remove H₂S down to approximately below 10 ppmw, or in a range of below 50 ppmw, 40 ppmw, 30 ppmw, 20 ppmw, 15 ppmw, 10 ppmw, 9 ppmw, 8 ppmw, 7 ppmw, 6 ppmw, 5 ppmw, 4 ppmw, 3 ppmw, 2 ppmw or 1 ppmw, or within a range of any of these values, or within, outside, or overlapping any range of these values before delivery of the liquid sulfur to the sulfur storage 80.

The embodiments described above provide a safer environment at the sulfur storage 80 and downstream of the sulfur storage 80, since degassed liquid sulfur is introduced to the sulfur storage 80 instead of liquid sulfur that has not been degassed. Sulfur storage 80 containing degassed sulfur significantly decreases the H₂S emissions that must be handled, increasing personnel safety by reducing risk for exposure and eliminating risk of reaching the Lower Explosion Limit at which the sulfur storage 80 has the potential to explode.

As described herein, the degassing device vessel 60 may be operatively coupled to the one or more pressure equalizers 26, 36, 43, 56, 90 such as the one or more sulfur sealing devices, located upstream and/or downstream of the degassing vessel 60, and/or one or more sulfur coolers 81 and/or process gas coolers 82 (e.g. heat exchangers, or the like), and/or the motive force device 83, the combination of one or more of these features may be described as a degassing system.

In still other embodiments of the invention the degassing system may be configured together on a skid (not illustrated). As such, the degassing system may comprise the skid, the one or more upstream pressure equalizers 26, 36, 43, 56 located upstream of the degassing device vessel 60, the degassing device vessel 60, the downstream pressure equalizer 90 located downstream of the degassing device vessel 60, the sulfur cooler 81, the process gas cooler 82, and/or the motive force device 83, some or all of which may be operatively coupled to each other within the skid. The skid may then be transported to and operatively coupled to, or within, existing sulfur recovery systems 10 or new sulfur recovery systems 10, for degassing liquid sulfur within the sulfur recovery systems 10. In this embodiment, the degassing system or one or more parts of the degassing system may be easily assembled to, or removed from, a sulfur recovery system 10 for replacement or repair. Moreover, the devices within the skid are located in the same area, and thus, may also be easily exchanged for repair with little interruption of service. In other embodiments, one or more of these features may be added to a sulfur recovery system 10 in order to create the degassing system within existing sulfur recovery units 10 and/or apart from use in a skid.

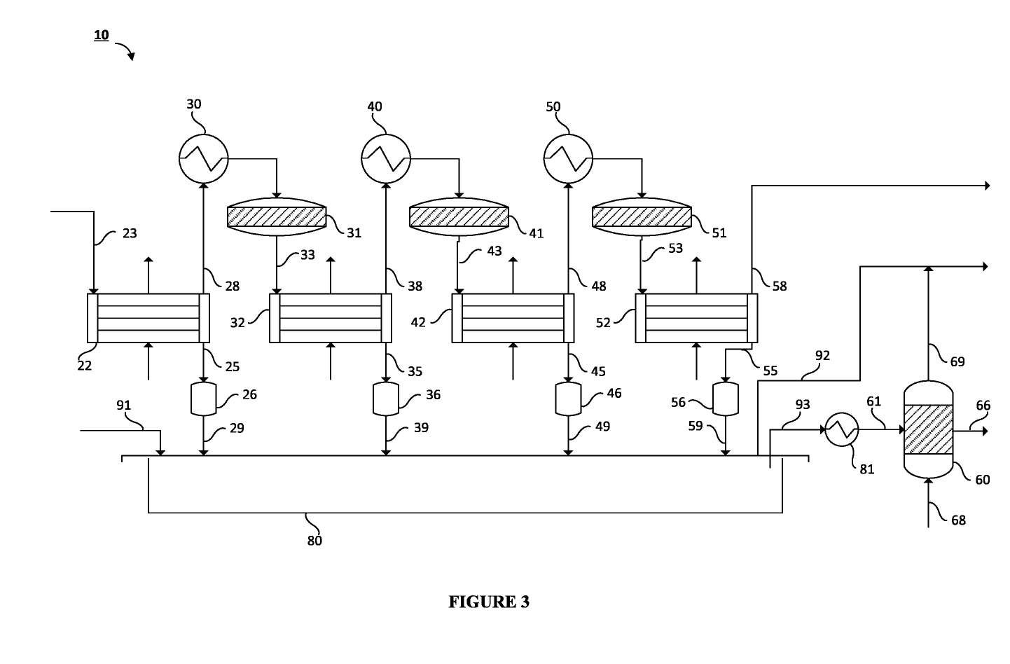

In an alternate embodiment of the invention, the degassing vessel 60 may be placed outside of the sulfur recovery system 10, as illustrated in FIG. 3. The degassing vessel 60, the degassing system, and/or the sulfur recovery system 10, illustrated in FIG. 3, may have components and functions as described herein (e.g., motive device, process gas cooler, sulfur cooler, or the like). In this embodiment, the degassing gas 68 may come from any one of the above mentioned sources (e.g., process gas slipstream from the SRU, and may be supplemented with gases from the Tail Gas Treatment Unit, steam, air, Nitrogen, or gases/fluids from within or outside the sulfur recovery system, at a suitable pressure). As illustrated in FIG. 3, in accordance with some embodiments, the degassing gas 69 exiting the contactor 60 may be sent to the incinerator via conduit 92, although the degassing gas 69 may be reinserted back into the SRU at a suitable location in other embodiments. A plurality of degassing gas sources and return locations is possible, as detailed above.

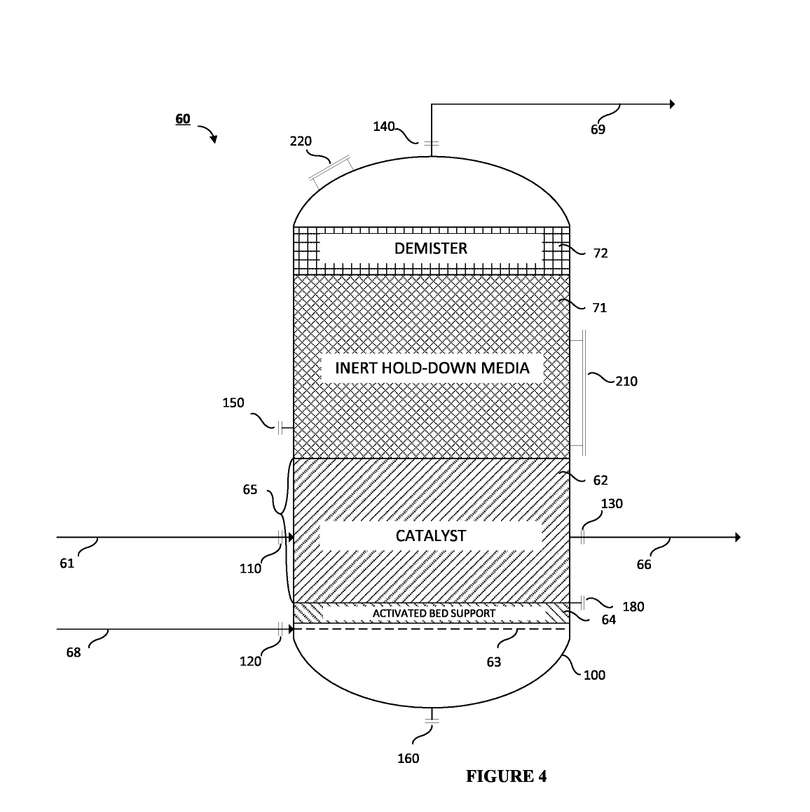

The degassing device vessel 60 will now be discussed in further detail with respect to FIGS. 4-6. Referring to FIG. 4, the device or vessel 60 for degassing liquid sulfur is illustrated in accordance with one embodiment of the invention.

The sulfur degassing vessel 60 is arranged to receive the liquid sulfur via conduit 61 (e.g., which receives liquid sulfur from one or more of conduits 29, 39, 49A, 59A). In other embodiments of the invention, the degassing vessel 60 may receive liquid sulfur directly from multiple conduits (e.g., from). Inside the vessel 60 is liquid sulfur with a contained catalyst 62 held within a catalyst zone 65. A degassed liquid sulfur discharge line 66 is arranged to remove liquid sulfur from the catalyst zone such that liquid sulfur entering the vessel 60 must pass completely through the catalyst zone 65 or at least through a portion of the catalyst zone 65.

The catalyst 62 may take one of several forms. The first form is a plurality of high surface area alumina particles (spheres, extrudates, rings, cylinders, etc.) constrained to prevent being removed or carried away by sulfur flow from the vessel 60. A second form is a plurality of similarly constrained high surface area alumina particles impregnated with iron oxides. A third form is one or more low surface area alumina porous ceramic foam supports coated with high surface alumina particles with or without impregnated iron oxide. In some embodiments, the catalyst 62 may be made of a monolith material (e.g. ceramic foam, metal foam, carbon foam, etc.) that is either embedded or suspended in structured packing or loose catalyst (e.g. beads, balls, etc.).

The catalyst 62 converts H₂Sₓ to H₂S and elemental sulfur. The productivity of the catalyst 62 is enhanced by agitation, especially by gas, such as the process gas described herein. A side reaction, which may occur in the catalyst zone 65 is additional conversion of H₂S to elemental sulfur. The process gas includes some SO₂ and may react on the surface of the catalyst with H₂S that may be condensed in the liquid sulfur, emanating from the liquid sulfur by the decomposition of H₂Sₓ, or contained in the process gas. This reaction is similar to the chemical reaction occurring in the Claus process and is generally described as: 2H₂S+SO₂ [symbol] 3/x Sₓ+2H₂O. Having additional active catalyst 62 for this chemical reaction to occur improves the overall sulfur recovery of the sulfur recovery system 10.

The catalyst 62 may be located or placed within the interior of the vessel housing 100 in various orientations. For example, in one embodiment, the catalyst 62 may be held in a basket. In another embodiment, the catalyst 62 may be placed directly into the vessel 60, or a catalyst housing 67 integral to or removable from vessel 60. In yet other embodiments, the catalyst 62 may be supplied pre-installed in a removable portion of the vessel 60 such as a removable disk, cylinder, or the like that includes the catalyst 62. The catalyst zone 65 may embody various shapes including, but not limited to, cylindrical (e.g. located within a pipe), rectangular (e.g. located within a box), spherical, and various other shapes not explicitly mentioned herein. Likewise, the catalyst 62 and/or the catalysts housing 67 forming the catalyst zone 65 may be positioned within the interior of the vessel housing 100 about various orientations including, but not limited to, vertically, horizontally, mounted at an angle, and various other orientations or combinations of orientations not explicitly mentioned herein. In this way, both liquid sulfur and process gas may enter and/or exit the vessel 60, or more specifically the catalyst 62 or catalyst zone 65, from the top, bottom, or sides of the vessel 60 or chambers located within the vessel 60.

In some embodiments, the catalyst 62 is supported with a bed support 64 to improve the mechanical resistance to the abrasion effects of the fluid flows within the degassing vessel 60 and to provide a structural support for the catalyst 62. Furthermore, the catalyst 62 may be held down with hold down media 71. This acts to prevent catalyst migration, and to minimize any interstitial movement between the catalyst particles or monoliths. The hold down media 71 may be designed to be resistant to thermodynamic shock and mechanical wear, as well as designed to minimize pressure drop within the vessel 60. Prior to the gas outlet 140, a demister pad may be utilized, in some embodiments, to prevent any entrained sulfur droplets from exiting the gas outlet 140. The demister “knocks out” any sulfur droplets from the process gas slipstream. If entrained sulfur droplets were to exit the contactor, they may prematurely damage the catalytic reactors 30, 40, 50.

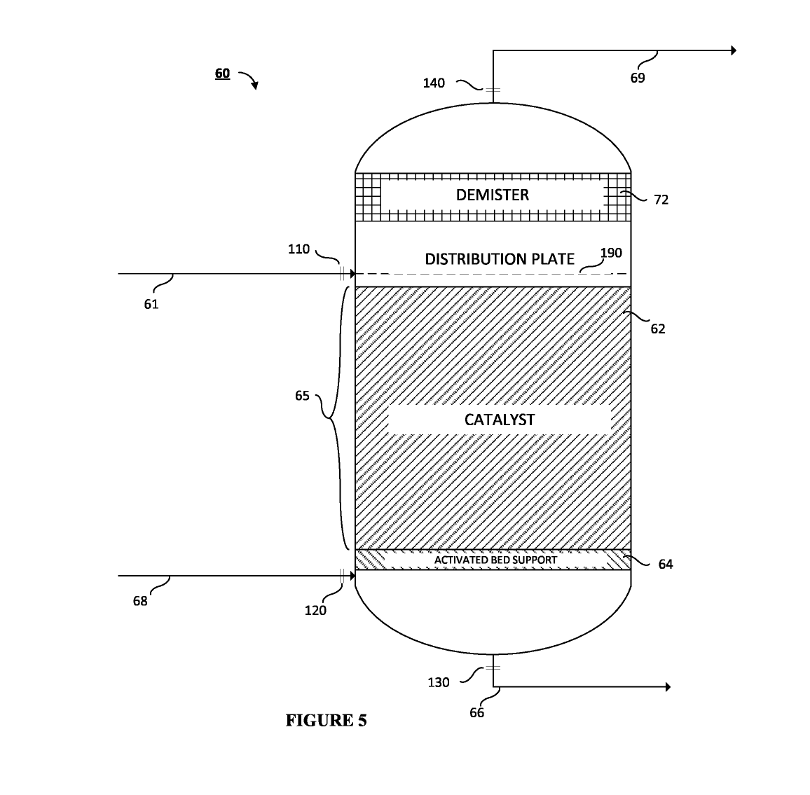

In the illustrated embodiment in FIG. 4 the catalyst is partially submerged within the liquid sulfur, and thus the liquid sulfur disengages from the gas within the presence of the catalyst 62. The disengagement occurs within the catalyst zone 65. In other embodiments, the liquid sulfur might disengage from the catalyst zone in the presence of the gas, as illustrated in FIG. 5. In alternative embodiments, based on the design of the catalyst housing 67, the catalyst is completely submerged within the liquid sulfur, and thus the liquid sulfur does not disengage from the process gas within the presence of the catalyst 62. The disengagement occurs after the liquid sulfur exits the catalyst zone 65.

As illustrated in FIGS. 4-6, the degassing vessel 60 for degassing liquid sulfur generally comprises: a housing 100 that includes a liquid sulfur inlet assembly 110 configured for coupling with a pipe and for directing the flow of liquid sulfur into the vessel 60; a process gas inlet assembly 120 configured for coupling with a pipe and for directing the flow of process gas into the vessel 60; a catalyst 62, forming a catalyst zone 65 and/or located within a catalyst housing 67; a liquid sulfur outlet assembly 130 configured for coupling with a pipe and for directing the flow of degassed liquid sulfur downstream within the pipe refinery circuit (e.g., to the pressure equalizer 90, such as the sulfur sealing device and/or the sulfur storage 80); and a process gas outlet assembly 140 configured for coupling with a pipe and for directing the flow of process gas back to the sulfur recovery system 10. As such, the vessel 60 allows for providing improved methods of removing hydrogen sulfide (e.g., H₂S) from the liquid sulfur and directing the recovered elemental liquid sulfur downstream to an above-ground, or alternatively a below-ground, pressure equalizer 90, such as a sulfur sealing device, and/or the sulfur storage 80.

In the vessel 60 illustrated in FIGS. 4-6, the inlet assemblies 110, 120 and outlet assemblies 130, 140 enter and exit the degassing device vessel 60 on the side walls of the vessel housing 100, but they can be located anywhere on or within the vessel housing 100.

The vessel 60 may further comprise one or more additional components including, but not limited to at least one viewpoint assembly. The viewpoint assembly is utilized for viewing the flow of liquid sulfur within the vessel 60, process gas, and/or for visual assessment of the levels of the catalyst 62. The vessel may also include a drain, rod out, or the like. In addition, the vessel 60 may further include an evacuation means to remove spent catalyst 62, and to provide entrance to the vessel 60 by means of a manway. Furthermore, the vessel 60 may be provided with a catalyst addition port to facilitate the loading of catalyst. A plurality of process instrumentation can be provided installed on the vessel 60 to aid in installation, commissioning and confirmation of operating status.

With respect specifically to the illustrated embodiment of FIG. 4, liquid sulfur may enter the vessel 60 from a first side of the vessel housing 100 through the liquid sulfur inlet assembly 110. The liquid sulfur may then flow across and/or upward throughout the catalyst zone 65 located in the interior of the vessel housing 100 such that it interacts with the catalyst 62. In other embodiments, pressure may force the liquid sulfur upward from the bottom of the vessel housing 100 such that it flows into the catalyst zone 65, such that degassed liquid sulfur leaves from upper portion of the vessel housing 100. Process gas may enter from the bottom portion of the vessel housing 100 through the process gas inlet assembly 120. The process gas may then flow upward from the bottom of the vessel housing 100, through a gas distribution plate 63 (e.g. sparger, sparging plate, perforated tube distributor, perforated plate, notched channeling troughs, or the like) and enter the catalyst zone 65. The process gas agitates the liquid sulfur in the presence of catalyst 62, thus removing H₂S from the liquid sulfur. The liquid sulfur exits from the catalyst zone 65 and out of the vessel housing 100 through the liquid sulfur outlet assembly 130. Moreover, the process gas, as well as the H₂S removed from the liquid sulfur, exits the submerged catalyst zone 65 from an upper surface of the vessel housing 100 through the process gas outlet assembly 140 and returns to the sulfur recovery system 10.

In an alternative embodiment shown in FIG. 5, the liquid sulfur may be received at the top of the vessel 60 and may be withdrawn at the bottom of the vessel 60. In this embodiment, the liquid sulfur is travelling counter to the flow of the process gas through the reaction zone 65. In FIG. 4, the catalyst zone 65 is shown as being liquid continuous, whereas, in the alternative embodiment shown in FIG. 5, the catalyst zone may be gas continuous with the liquid sulfur trickling down through the catalyst zone 65.

As further illustrated in FIG. 5, a pan 190 may be positioned above the catalyst zone 65. The pan 190 is utilized to control the flow of liquid sulfur into and through the catalyst 62. The pan 190 may be utilized to evenly distribute the liquid sulfur across the width of the catalyst zone 65.

With respect to the various component orientations shown in the illustrated embodiment of FIG. 5, liquid sulfur may enter the vessel 60 from a first side of the vessel housing 100 through the liquid sulfur inlet assembly 110. The liquid sulfur may then flow downward and be evenly distributed in the pan 190, and then disperse into the catalyst zone 65 from the pan 190 with the catalyst 62 located in the interior of the vessel housing 100. After flowing throughout catalyst zone 65 and interacting with the catalyst 62, the liquid sulfur may exit from the bottom of the vessel housing 100 through the liquid sulfur outlet assembly 130. At the same time process gas may enter from the bottom of the vessel housing 100 through the process gas inlet assembly 120 and travel upward into the catalyst zone 65 with the catalyst 62. When flowing throughout the catalyst zone 65, the process gas interacts with the liquid sulfur falling downwardly from the liquid sulfur inlet assembly 110, and then subsequently exits the catalyst zone 65 and out of the vessel housing 100 through the process gas outlet assembly 140. In such an embodiment, sulfur disengages from the process gas as the process gas passes through the liquid sulfur and as the liquid sulfur passes through the catalyst 62.

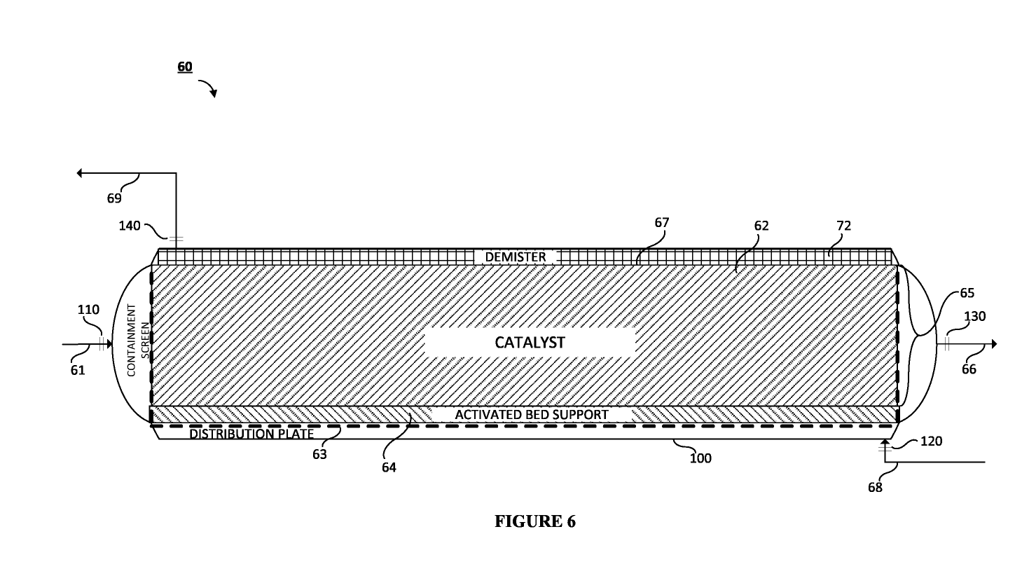

FIG. 6 illustrates an embodiment comprising a horizontal vessel with horizontal catalyst zone 65. In a specific embodiment, the vessel housing 100 may be defined by a horizontal pipe section 101. In such an embodiment the integral horizontal pipe formed by the inlet and outlet assemblies 110, 130 defines the vessel housing 100. For example, in some embodiments, the liquid sulfur inlet assembly 110 and the liquid sulfur outlet assembly 130 may be positioned in-line in a substantially horizontal linear orientation such that their respective pipe sections 114, 134 form an integral horizontal pipe that has an aperture therethrough. In such an embodiment the integral horizontal pipe formed by the inlet and outlet assemblies 110, 130 defines the opposite end portions of the vessel housing 100, as illustrated by FIG. 6. Although in other embodiments, one or both of the liquid sulfur inlet assembly 110 and the liquid sulfur outlet assembly 130 may be positioned on the sidewalls of the horizontal pipe. In some embodiments, the liquid sulfur inlet assembly 110 is positioned within the catalyst zone 65 such that liquid directly enters the catalyst housing 67 from the liquid sulfur inlet assembly 110.

As illustrated by FIG. 6, the process gas inlet assembly 120 may be positioned on the bottom surface of the vessel housing 100 proximate to the liquid sulfur outlet assembly 130, such that the flow of the liquid sulfur as it enters the vessel housing 100 through the liquid sulfur inlet assembly 110 is counter to the flow of the process gas from the process gas inlet assembly 120 for increased agitation of the liquid sulfur. In other embodiments, the process gas inlet assembly 120 may be positioned on the bottom surface of the vessel housing 100 proximate to the liquid sulfur inlet assembly 110, allowing the process gas to mix with the liquid sulfur as it enters the vessel housing 100 through the liquid sulfur inlet assembly 110.

As further illustrated in FIG. 6, the catalyst zone 65 may be a horizontal core pipe, located within the interior of the vessel housing 100 and creating a recess between the core pipe of the catalyst housing 67 and the inner wall of the vessel housing 100. The core pipe may comprise a plurality of perforations 63 located, at least, alongside the bottom, top surfaces, and/or other surfaces of the core pipe that allow gas to enter and/or exit the catalyst housing 67. The catalyst 62 may be substantially located within the interior of the core pipe such that it extends from the liquid sulfur inlet assembly 110 to the liquid sulfur outlet assembly 130. The recess allows for process gas to enter into the vessel 60 and bubble up into the core pipe through the various perforations located in the bottom of the core pipe, and additionally allows for process gas to bubble up into the various perforations located in the top of the core pipe and exit the core pipe and subsequently the vessel 60. The process gas agitates the liquid sulfur in the presence of catalyst 62, thus removing H₂S from the liquid sulfur, similar to the embodiments described previously.

The process gas outlet assembly 140 may be positioned on the top surface of the vessel housing 100 proximate to the liquid sulfur inlet assembly 120 or proximate to the liquid sulfur outlet assembly 130 for allowing the gas to exit the vessel housing 100 and rejoin the sulfur recovery system 10. The process gas inlet assembly 120 and the process gas outlet assembly 140 may be positioned on the sidewalls of the horizontal pipe or on the end portions of the horizontal pipe.

In some embodiments the catalyst zone 65 and/or the vessel housing 100 may contain one or more partitions (e.g., mesh partitions, or the like), arranged adjacent to one another in any suitable configuration. The catalyst 62 may be located within and enclosed by the one or more partitions. In some embodiments, at least a portion of the walls of the partitions may comprise apertures or recesses to allow liquid sulfur and/or the process gas to flow through.

Alternate embodiments of a sparger 63, alluded to throughout this specification, are now described. In some embodiments, the vessel housing 100 may further comprise a sparger 63, typically positioned at the inlet of the process gas, configured to allow vigorous stirring of the catalyst 62 by the process gas. The sparger 63 may be embodied by various sparger designs including, but not limited to, a fixed sparger plate, a removable sparger plate, a pipe style sparger, a pipe and manifold style sparger, or the like. For example, the sparger 63, comprises one or more perforations to allow for process gas to bubble upwards through the catalyst and exit the vessel housing 100. In other embodiments, the process gas inlet assembly 120 may direct the flow of process gas into a specific type of process gas distribution housing, such as an enclosed pipe housing having one or more perforations located in the top of the enclosed pipe (e.g. sparger pipe 63) to allow for process gas to bubble upwards throughout the vessel housing. It should be understood that a sparger and/or any other type of process gas distribution system may be utilized to deliver the process gas to the liquid sulfur both for vertical and horizontal pipe housings 100.

It should be understood that the liquid sulfur inlet assembly 110, the liquid sulfur outlet assembly 130, the process gas inlet assembly 120, and the process gas outlet assembly 140 may be located on any surface of the vessel 60 and operate in the various ways described herein. Moreover, portions of various embodiments of the invention described herein may be combined with other portions of different embodiments of the invention described herein, to form other embodiments of the present that are not specifically disclosed in a single illustrated embodiment, but instead make up one or more combinations of the various embodiments described herein.

The present invention is described herein as being utilized within a refinery, and particularly for use with sulfur recovery systems (also described as sulfur recovery units) within a refinery. It should be understood that in other embodiments of the invention the degasser device vessel 60, and degassing system, may be utilized in other systems that require degassing.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A degassing system for a sulfur recovery system, comprising:
a degassing vessel, wherein the degassing vessel is configured to receive liquid sulfur from one or more condensers and process gas from any location of the sulfur recovery system, wherein the degassing vessel outputs degassed liquid sulfur for storage, and wherein the degassing vessel returns the process gas used to degas the liquid sulfur to the sulfur recovery system at any location; and
a downstream pressure equalizer, wherein the downstream pressure equalizer receives the degassed liquid sulfur from the degassing vessel, separates the degassed liquid sulfur from any remaining gas, and delivers the degassed liquid sulfur to sulfur storage without the remaining gas.

2. The degassing system of claim 1, further comprising:
a motive force device configured to supplement pressure of the process gas exiting the degassing vessel and being returned to the sulfur recovery system.

3. The degassing system of claim 1, further comprising:
at least one sulfur cooler configured to receive the liquid sulfur from the one or more condensers, cool the liquid sulfur to lower the solubility of H₂S before delivering the liquid sulfur to the degassing vessel, and deliver the liquid sulfur to the degassing vessel.

4. The degassing system of claim 1, further comprising:
at least one gas cooler configured to receive the process gas from the sulfur recovery system, cool the process gas to prevent polymerization of the degassed liquid sulfur or reintroduction of H₂S in the degassed liquid sulfur, and provide the process gas to the degassing vessel.

5. The system of claim 1, wherein the liquid sulfur is received from one or more upstream pressure equalizers located downstream of the one or more condensers and upstream of the degassing vessel, and wherein the one or more upstream pressure equalizers are configured to receive the liquid sulfur from the one or more condensers, separate the process gas from the liquid sulfur, and deliver the liquid sulfur to the degassing vessel.

6. A degassing system for a sulfur recovery system, comprising:
a degassing vessel, wherein the degassing vessel is configured to receive liquid sulfur from one or more condensers and process gas from any location of the sulfur recovery system, wherein the degassing vessel outputs degassed liquid sulfur for storage, and wherein the degassing vessel returns the process gas used to degas the liquid sulfur to the sulfur recovery system at any location; and
a motive force device configured to supplement pressure of the process gas exiting the degassing vessel and being returned to the sulfur recovery system.

7. The system of claim 6, further comprising:
a downstream pressure equalizer, wherein the downstream pressure equalizer receives the degassed liquid sulfur from the degassing vessel, separates the degassed liquid sulfur from any remaining gas, and delivers the degassed liquid sulfur to sulfur storage without the remaining gas.

8. The degassing system of claim 6, further comprising:
at least one sulfur cooler configured to receive the liquid sulfur from the one or more condensers, cool the liquid sulfur to lower the solubility of H₂S before delivering the liquid sulfur to the degassing vessel, and deliver the liquid sulfur to the degassing vessel.

9. The degassing system of claim 6, further comprising:
at least one gas cooler configured to receive the process gas from the sulfur recovery system, cool the process gas to prevent polymerization of the degassed liquid sulfur or reintroduction of H₂S in the degassed liquid sulfur, and provide the process gas to the degassing vessel.

10. The system of claim 6, wherein the liquid sulfur is received from one or more upstream pressure equalizers located downstream of the one or more condensers and upstream of the degassing vessel, and wherein the one or more upstream pressure equalizers are configured to receive the liquid sulfur from the one or more condensers, separate the process gas from the liquid sulfur, and deliver the liquid sulfur to the degassing vessel.

11. A degassing system for a sulfur recovery system, comprising:
a degassing vessel, wherein the degassing vessel is configured to receive liquid sulfur from one or more condensers and process gas from any location of the sulfur recovery system, wherein the degassing vessel outputs degassed liquid sulfur for storage, and wherein the degassing vessel returns the process gas used to degas the liquid sulfur to the sulfur recovery system at any location; and
at least one sulfur cooler configured to receive the liquid sulfur from the one or more condensers, cool the liquid sulfur to lower the solubility of H₂S before delivering the liquid sulfur to the degassing vessel, and deliver the liquid sulfur to the degassing vessel.

12. The system of claim 11, further comprising:
a downstream pressure equalizer, wherein the downstream pressure equalizer receives the degassed liquid sulfur from the degassing vessel, separates the degassed liquid sulfur from any remaining gas, and delivers the degassed liquid sulfur to sulfur storage without the remaining gas.

13. The system of claim 11, further comprising:
a motive force device configured to supplement pressure of the process gas exiting the degassing vessel and being returned to the sulfur recovery system.

14. The degassing system of claim 11, further comprising:
at least one gas cooler configured to receive the process gas from the sulfur recovery system, cool the process gas to prevent polymerization of the degassed liquid sulfur or reintroduction of H₂S in the degassed liquid sulfur, and provide the process gas to the degassing vessel.

15. The system of claim 11, wherein the liquid sulfur is received from one or more upstream pressure equalizers located downstream of the one or more condensers and upstream of the degassing vessel, and wherein the one or more upstream pressure equalizers are configured to receive the liquid sulfur from the one or more condensers, separate the process gas from the liquid sulfur, and deliver the liquid sulfur to the degassing vessel.

16. A degassing system for a sulfur recovery system, comprising:
a degassing vessel, wherein the degassing vessel is configured to receive liquid sulfur from one or more condensers and process gas from any location of the sulfur recovery system, wherein the degassing vessel outputs degassed liquid sulfur for storage, and wherein the degassing vessel returns the process gas used to degas the liquid sulfur to the sulfur recovery system at any location; and
at least one gas cooler configured to receive the process gas from the sulfur recovery system, cool the process gas to prevent polymerization of the degassed liquid sulfur or reintroduction of H₂S in the degassed liquid sulfur, and provide the process gas to the degassing vessel.

17. The system of claim 16, further comprising:
a downstream pressure equalizer, wherein the downstream pressure equalizer receives the degassed liquid sulfur from the degassing vessel, separates the degassed liquid sulfur from any remaining gas, and delivers the degassed liquid sulfur to sulfur storage without the remaining gas.

18. The system of claim 16, further comprising:
a motive force device configured to supplement pressure of the process gas exiting the degassing vessel and being returned to the sulfur recovery system.

19. The degassing system of claim 16, further comprising:
at least one sulfur cooler configured to receive the liquid sulfur from the one or more condensers, cool the liquid sulfur to lower the solubility of H₂S before delivering the liquid sulfur to the degassing vessel, and deliver the liquid sulfur to the degassing vessel.

20. The system of claim 16, wherein the liquid sulfur is received from one or more upstream pressure equalizers located downstream of the one or more condensers and upstream of the degassing vessel, and wherein the one or more upstream pressure equalizers are configured to receive the liquid sulfur from the one or more condensers, separate the process gas from the liquid sulfur, and deliver the liquid sulfur to the degassing vessel.

21. A degassing system for a sulfur recovery system, comprising:
a degassing vessel, wherein the degassing vessel is configured to receive liquid sulfur from one or more upstream pressure equalizers located downstream of one or more condensers and upstream of the degassing vessel and process gas from any location of the sulfur recovery system, and wherein the one or more upstream pressure equalizers are configured to receive the liquid sulfur from the one or more condensers, separate the process gas from the liquid sulfur, and deliver the liquid sulfur to the degassing vessel, wherein the degassing vessel outputs degassed liquid sulfur for storage, and wherein the degassing vessel returns the process gas used to degas the liquid sulfur to the sulfur recovery system at any location;
a downstream pressure equalizer, wherein the downstream pressure equalizer receives the degassed liquid sulfur from the degassing vessel, separates the degassed liquid sulfur from any remaining gas, and delivers the degassed liquid sulfur to sulfur storage without the remaining gas;
a motive force device configured to supplement pressure of the process gas exiting the degassing vessel and being returned to the sulfur recovery system;
at least one sulfur cooler configured to receive the liquid sulfur from the one or more condensers, cool the liquid sulfur to lower the solubility of H₂S before delivering the liquid sulfur to the degassing vessel, and deliver the liquid sulfur to the degassing vessel; and
at least one gas cooler configured to receive the process gas from the sulfur recovery system, cool the process gas to prevent polymerization of the degassed liquid sulfur or reintroduction of H₂S in the degassed liquid sulfur, and provide the process gas to the degassing vessel.
